(19) United States
(12) Patent Application Publication
(10) Pub. No.: US 2018/0094777 A1
(43) Pub. Date: Apr. 5, 2018

(54) FLEXIBLE LED FILAMENT

(71) Applicant: Burton VARGAS-CHAMBERS, Oakland, CA (US)

(72) Inventor: Burton VARGAS-CHAMBERS, Oakland, CA (US)

(21) Appl. No.: 15/285,414

(22) Filed: Oct. 4, 2016

(51) Int. Cl. F21K 9/237; F21V 19/02; F21V 23/00; F21V 3/02; F21K 9/232; F21K 9/238; F21V 9/16; F21K 9/235; F21K 9/90; F21S 4/22; F21K 9/64; F21K 9/66; F21V 3/04

(52) U.S. Cl. CPC F21K 9/237; F21V 19/02; F21V 23/003; F21V 3/02; F21K 9/232; F21K 9/238; F21Y 2115/10; F21K 9/235; F21K 9/90; F21S 4/22; F21K 9/64; F21K 9/66; F21V 3/0481; F21V 9/16

(57) ABSTRACT

A flexible LED filament comprises a plurality of light emitting diodes (LEDs) mounted to a flexible substrate configured with a length at least ten times a width and LEDs distributed substantially uniformly along the length. The length of the flexible substrate is disposed along a curved path, and the LED filament looks substantially like an incandescent filament when lit. A polymer coating may be disposed over and around the flexible substrate and the plurality of LEDs and configured to scatter or diffuse light from the plurality of LEDs such that the light-emitting device appears to emit light substantially uniformly along its length, and discrete LEDs cannot be discerned. The polymer coating may further comprise a phosphor operable to convert light emitted by the plurality of LEDs to longer wavelengths.

### FIELD OF THE INVENTION

One or more embodiments of the present invention relates to LED filaments and methods of making thereof.

### BACKGROUND

There is a major technology shift in progress in the lighting industry manifested as a change to solid-state light emitters such as LEDs that can provide higher efficiency, longer lifetime and greater design flexibility. At the same time, there continues to be a market interest in lighting elements that look like familiar and vintage products such as incandescent lightbulbs of many shapes and power outputs.

Recently, several companies including PLT (Precision Lighting and Transformer, Inc., Garland, Tex.), AXP Technology, Inc. (Fremont, Calif.) and GreenCreative (San Bruno, Calif.) have introduced “antique LED filament bulbs” which mimic the appearance of antique incandescent bulbs using an “LED filament.” All of these products use a “Chip-on-Glass” (COG) filament constructions whereby a linear array of small LEDs are mounted on a straight thin glass or sapphire substrate. Details vary, but a typical LED filament comprises, for example, 40 blue LEDs are mounted on a glass substrate. The assembly is then coated in a silicone polymer loaded with a phosphor which converts a portion of the blue light to longer wavelengths to provide net “white” light (see, for example, www.ledinside.com/knowledge/2015/2/the_next_generation_of_led_filament_bulbs).

U.S. Patent Application Publication No. 2014/0369036 to Yunlong Feng discloses an embodiment of an LED filament as described above with a substrate having an elongated bar construction and comprising a high-temperature transparent ceramic or glass.

LED filaments only approximate the appearance of a tungsten filament, being generally thicker and having color behavior which is different from that of a tungsten filament. However, to a casual observer, the appearances of an LED filament and a tungsten filament are similar. Further, an LED filament can provide new design flexibility in that any glass bulb envelope is purely decorative, optional, and need not even be made from glass. For antique bulb replacements, clear bulbs are typically used, and driver electronics are located in the base of the bulb.

The COG construction generally limits these products to straight filaments, however, and available products are designed to mimic antique bulb designs having clear bulbs and one or more straight filament segments. There is a need for LED filaments that can be formed into other shapes.

### SUMMARY OF THE INVENTION

A flexible LED filament comprises a plurality of light emitting diodes (LEDs) mounted to a flexible substrate configured with a length at least ten times a width and LEDs distributed substantially uniformly along the length. The length of the flexible substrate is disposed along a curved path, and the LED filament looks substantially like an incandescent filament when lit. A polymer coating may be disposed over and around the flexible substrate and the plurality of LEDs and configured to scatter or diffuse light from the plurality of LEDs such that the light-emitting device appears to emit light substantially uniformly along its length, and discrete LEDs cannot be discerned. The polymer coating may further comprise a phosphor operable to convert light emitted by the plurality of LEDs to longer wavelengths. The polymer coating can comprise silicone.

At least a portion curved path can have a helical shape, although the filament can be formed into any desired curved path. A bulb-shaped envelope can be provided surrounding the flexible substrate. A driver can be provided, operable to provide controlled electrical current to the plurality of LEDs. The assembly can mimic any incandescent bulb having, for example, any size of a screw- or bayonet-style base.

Light emitting devices of the subject invention can be made by forming a printed circuit on an elongated flexible substrate, the substrate having a length at least ten times a width, mounting and electrically connecting a plurality of LEDs on the elongated flexible substrate, coating the elongated flexible substrate with a polymer coating, and forming the elongated flexible substrate into a curved shape. Optionally, the polymer coating can be loaded with a phosphor operable to convert light emitted by the plurality of LEDs to longer wavelengths. The two ends of the elongated flexible substrate can be attached to a lamp base. A driver circuit can be mounted in the lamp base and electrical pads at the two ends of the elongated flexible substrate can be connected to the output terminals of the driver circuit. The LED filament can be mounted inside a transparent glass or plastic envelope.

### BRIEF DESCRIPTION OF THE DRAWINGS

FIG. 1 A-F show various embodiments of a helical LED filament mounted into bulbs of varying shape.

FIG. 2 shows two LED filaments interleaved to form a double helix.

FIG. 3 shows a tapered or conical LED filament.

FIG. 4 shows an LED filament formed into a heart shape.

FIG. 5 shows an LED filament formed into the shape of a smiley face.

FIG. 6 shows an LED filament formed into the shape of a San Francisco Giants logo.

### DETAILED DESCRIPTION

Before the present invention is described in detail, it is to be understood that unless otherwise indicated this invention is not limited to specific circuits, appliances, or network architectures. It is also to be understood that the terminology used herein is for the purpose of describing particular embodiments only and is not intended to limit the scope of the present invention. Typical examples are described for residential appliances and devices, but other devices and installation settings can similarly benefit from the systems and methods described herein.

It must be noted that as used herein and in the claims, the singular forms “a,” “and” and “the” include plural referents unless the context clearly dictates otherwise. Thus, for example, reference to “a filament” includes two or more filaments, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. The term “about” generally refers to ±10% of a stated value. The term “substantially all” generally refers to an amount greater than 95% of the total possible amount.

### Definitions

As used herein, the term “LED filament” refers to a string of small LEDs mounted onto a substrate and electrically connected such that the LEDs can be illuminated. The mounted LEDs are further coated with a polymer matrix that at least diffuses the light such that the filament appears to be a continuous glowing string that mimics an incandescent filament. Typically (but not necessarily), the polymer matrix further comprises a phosphor which converts some emitted light to extend the spectral content of the net light emitted by the filament.

Embodiments of the present invention provide novel LED filaments that enable a wide variety of new design options for lightbulbs and luminaires. As with the straight LED filaments known in the prior art, the instant filaments are intended to be seen and to mimic incandescent filaments. Unlike prior art filaments, the instant filaments are flexible and can be configured in curved and coiled shapes. These newly available filament shapes can be used to mimic similar shapes used with tungsten filaments and to create new shapes not readily achievable with a tungsten filament.

In some embodiments, flexible LED filaments are built onto thin strips of a flexible printed circuit material such as polyimide (e.g., KAPTON®, EI du Pont de Nemours and Co., Wilmington, Del.), PEEK (polyether ether ketone), or polyester. Polyimide can be advantageous where high temperatures may be encountered (depending on the power level at which the LED filament is to be operated), because polyimide can be used continuously up to about 260° C. and briefly (e.g., for soldering) up to about 700° C. LEDs can be mounted on one or both sides of the flexible printed circuit. Optional additional components can also be mounted on the same circuit board as may be useful for particular drive circuitry. Typically, surface-mount LED packages having a minimal form factor are used to minimize the apparent width of a finished filament. There is no particular limitation as to the electrical arrangement (connections) implemented on the printed circuit. An exemplary LED filament may have about 40 discrete LEDs connected in series, so that the net effect is light emission along a line, but greater or lesser numbers of discrete LEDs can be used. However, any suitable combination of series and parallel connections can be used. Further, the LEDs in an LED filament can be configured as “AC-LEDs” by arranging individual LEDs such that a subset of the LEDs conducts during each half cycle of an AC waveform.

LED filaments can be constructed using LEDs of any suitable type. As noted above, a typical LED filament uses a miniature surface-mount package, but beyond the desirability of a small form factor, there are no particular requirements. LEDs can be selected for color, power, or any other relevant operating parameter. An individual LED filament may comprise matched LEDs of a single type or mixed types (such as multiple colors). The LED packages can also include a phosphor coating (“phosphor coated” or pcLEDs) as is typical of so-called “white” LEDs.

While an LED filament can be operated with no additional coating, in some embodiments, the flexible circuit with mounted LEDs is further coated with a transparent or translucent polymer, optionally loaded with a pigment to diffuse or scatter light. Such light scattering can be uses to convert the series of discrete light emitting points defined by the individual LEDs into a filament which appears to glow uniformly and more accurately mimic a glowing incandescent filament.

In some embodiments, at least a portion of the pigment in the coating polymer comprises a phosphor. Phosphors are commonly used with LEDs to convert at least of portion of the emitted light from an LED to another wavelength, typically a longer wavelength. For example, “white” LEDs are commonly made by starting with a blue or violet LED and using a phosphor with a broad peak in the yellow-green to convert a portion of the blue light to green/yellow/orange/red so that the net color appearance is white.

LED filaments can be made to emit any desired color or combination of colors. For antique/vintage bulb mimics, it is typically desired to target a “warm white” color having more red than is commonly used for general LED lighting applications where maximum electrical efficiency (typically expressed as lumens per electrical watt) is paramount. The extra red emission can be achieved by including red LEDs or by selecting a phosphor or phosphors with more emission in the red. Absorbing pigments can also be used to alter the apparent color of the LED filament, although any absorption mechanism will tend to reduce the overall electrical efficiency. While many applications may target a warm white color for the net appearance of an LED filament, in some embodiments, colored LED filaments having any hue can be provided using any combination of colored LEDs, phosphors, and absorbing pigments.

In some embodiments, the “warm” appearance of a filament can be further enhanced by choosing a power level (brightness) such that the filament can be comfortably viewed directly. Low-power filaments that can be viewed directly can still contribute to overall illumination provided a sufficient total number of filaments is provided. At the same time, low-power filaments can provide a decorative or display function for architectural design, scenic design, as well as signage and promotional purposes.

In some embodiments, LED filaments having variable hue have a plurality of color channels (such as, but not limited to, red, green, and blue) which can be independently dimmed. As for single color filaments, each color channels can be implemented using any combination of colored LEDs, phosphors, and absorbing pigments.

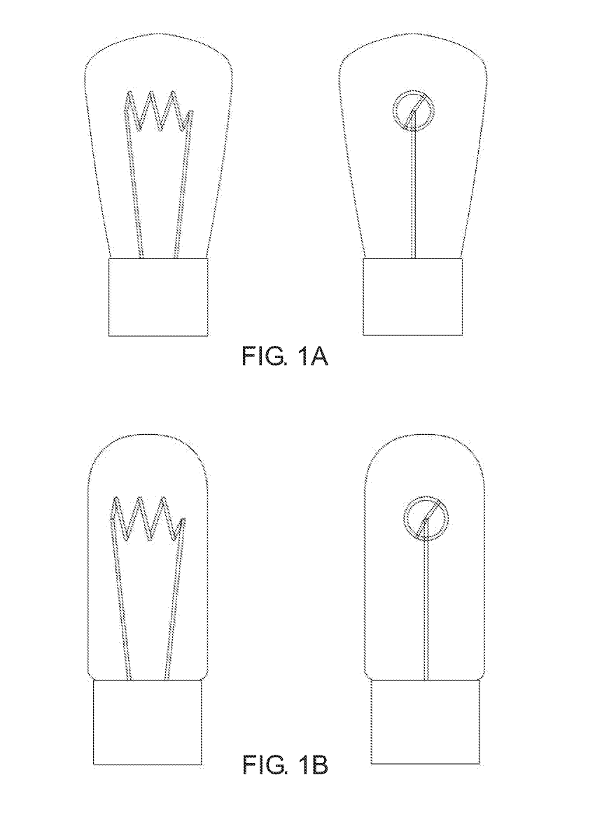

LED filaments can be made having any convenient length and number of LEDs. The number of LEDs can be selected for the convenience of electrical design (e.g., a total voltage needed to drive a series string) or to achieve a desired total light output or light-emitting string length. FIG. 1 shows examples of a coiled filament design wherein a single LED filament is formed into a helical coil. Alternative envelope shapes A-F are illustrated. However, the particular arrangement of one or more filaments into curved shapes and then into bulbs, tubes, and luminaires is limited only by the imagination of the designer. For example, the diameter and pitch of the coil may vary, and the coil may be mounted in any orientation relative to the envelope and base. One alternative orientation is rotated 90 relative to the coils of FIG. 1 such that the coil appears to be vertical instead of horizontal. Coils can also have a curved axis, where the plane of the axis arc (or circle) can have any orientation.

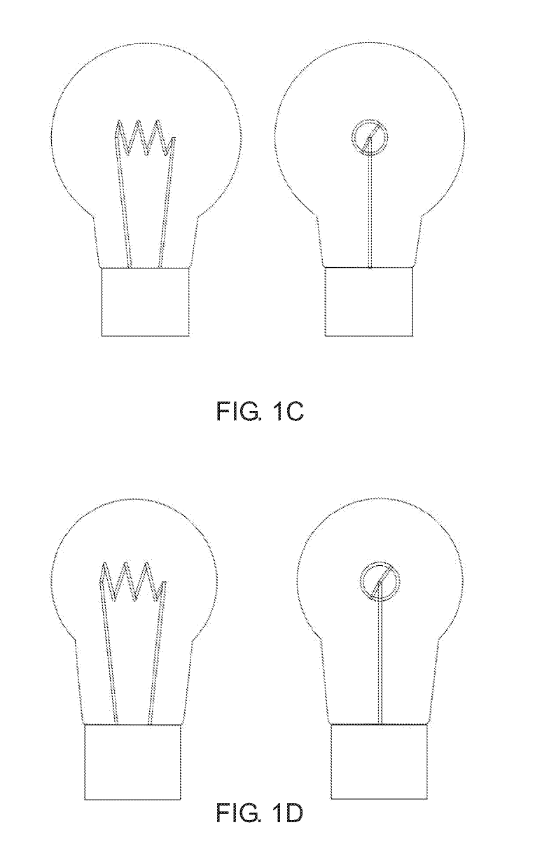

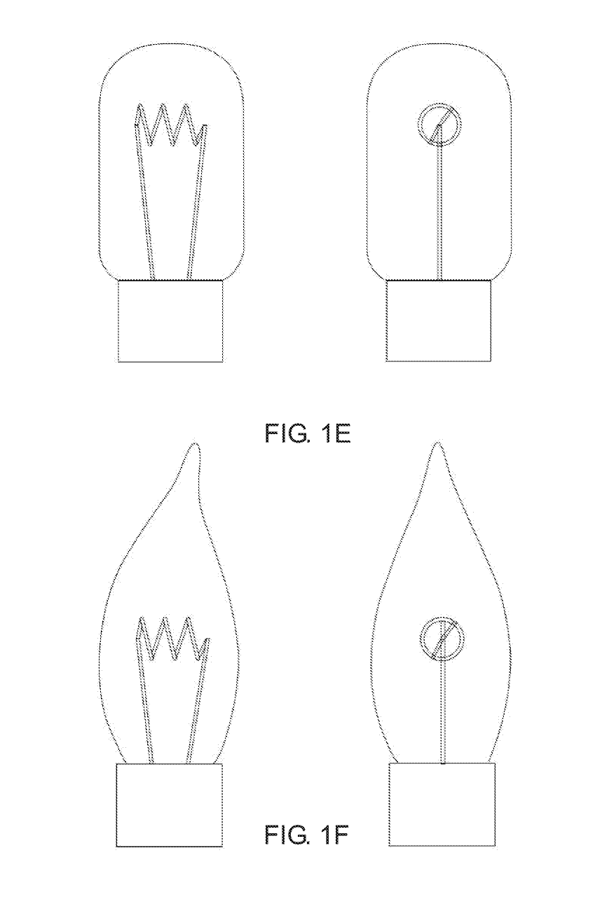

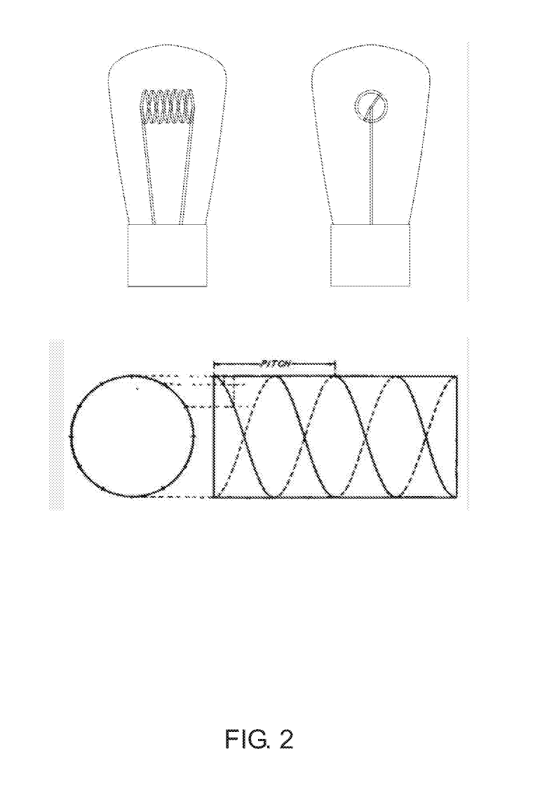

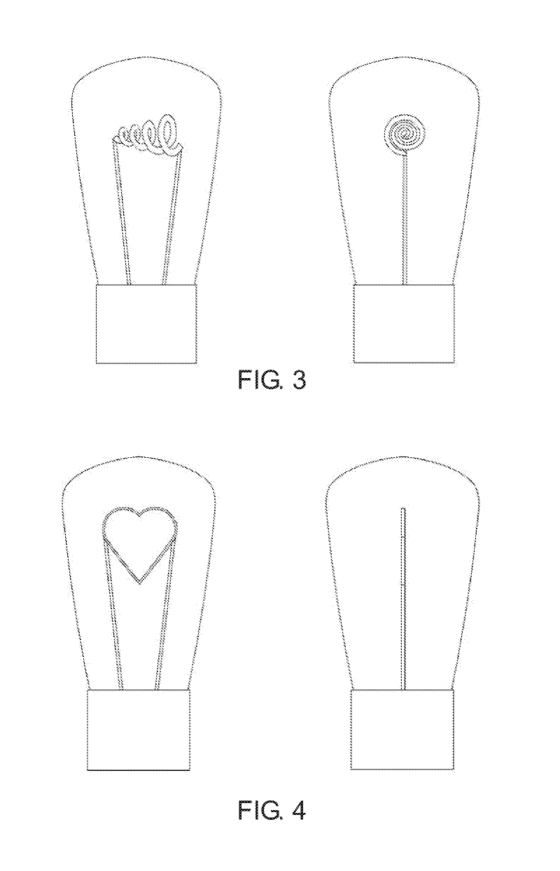

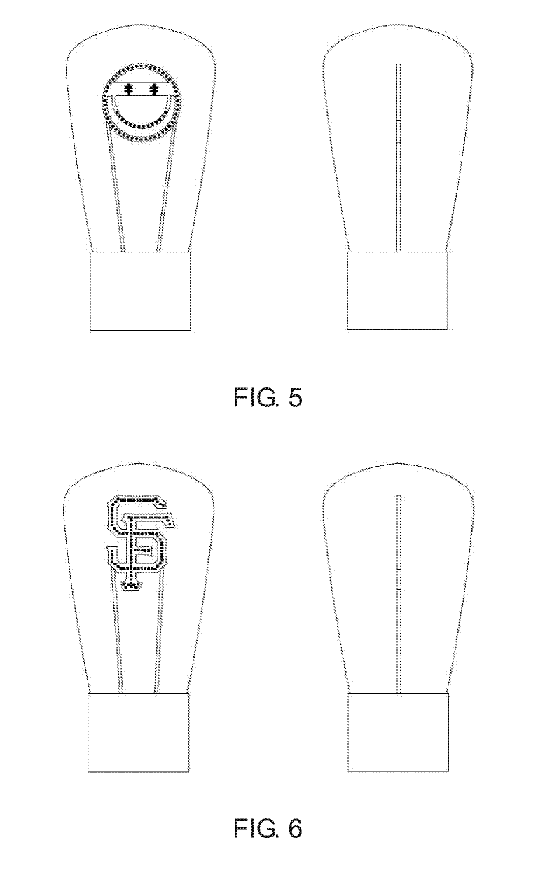

Additional examples of filament shapes are shown in FIGS. 2-6. FIG. 2 shows a double helix version of the coil with two coils interleaved. FIG. 3 shows a cone or spiral shape where the diameter of the coil increases from one end to the other. FIGS. 4-6 shows three decorative shapes: a heart (FIG. 4), a smiley face (FIG. 5), and a San Francisco Giants logo (FIG. 6). These are shown in an upright orientation for bulbs mounted above the base. It will be readily understood that such shapes can be created rotated as desired (for example, by 90° or 180° for bases mounted to a wall or ceiling).

Shapes such as the examples illustrated in FIGS. 5 and 6 may or may not be formed from one or more continuous LED filaments. As illustrated, these shapes are custom manufactured by mounting LEDs at the desired locations on a flexible substrate which has been die-cut to provide sufficient mounting area for the LEDs. The LEDs can be connected in any desired series and/or parallel connection. The assembled circuit board can be further coated with a transparent or translucent polymer, optionally loaded with a pigment to diffuse or scatter light as for LED filaments which are formed as single lines. At least a portion of the pigment in the coating polymer can comprise a phosphor. A heart shape as in FIG. 4 can also be made in this way.

In some embodiments, at least one linear dimension of the shape is larger than the opening in the envelope. In these embodiments, the assembled circuit can be bent or rolled to fit through the opening and then unbent or unrolled to a desired shape such as the planar designs in FIGS. 5 and 6.

In some embodiments, complex shapes such as those of FIGS. 5 and 6 can be made using LED filaments. For example, if the coating polymer is selected such that the filament can be bent and hold a bent shape, then any specific radius or corner can be formed. Discontinuities in the illuminated filament can be created by either omitting LEDs for discrete lengths of filament substrate, or covering such discrete lengths with an opaque coating.

Shapes made from flexible LED filaments can also be used without envelopes, for example, to replace neon signage. For all such decorative shapes, colored LEDs may be preferred, and it may be advantageous to have the LEDs wired in multiple columns arranged in parallel to allow use of a large total number of LEDs at a convenient operating voltage and multiple colors.

In some embodiments, an LED filament is mounted onto a base with a standard bulb or tube connection corresponding to a traditional lighting standard. For example, a bulb-replacement product can have a screw- or bayonet-type base as is known in the art. For new designs, a designer may, of course, use any available connector to suit design needs. Examples of common bases are defined by various bulb standards. For example, screw-style bases are designated “En” where standard values of n are 5, 10, 11, 12, 14, 17, 26, 27, 29, 39, and 40, the numbers being base diameters in mm. (E26 is the commonly used “medium” base for general purpose incandescent lighting at 120 VAC; E27 is the equivalent base for 240 VAC; E12 and E14 are for the same two voltages in “candelabra” style bulbs, and so on). Bayonet-style bases are similarly designated “BAn” where standard values of n are 5, 7, 9, 15, 20, 21, and 22 (again diameter in mm). Many countries of the former British Commonwealth use bayonet bases instead of screw bases for general-purpose lighting at 240 VAC. The “medium” base in bayonet-style is “BA22d,” also known as “BC.” Variations also exist for extra pins to support two or more separately powered filaments and/or security keying for specialty applications.

While an LED filament requires no special enclosure or protection, any such enclosure can be used to achieve a particular design effect. For example, a glass envelope (or plastic equivalent) can be used to provide an appearance similar to both “standard” and “antique” or “vintage” bulb or tube designs. Typically (but not necessarily), the envelope should be transparent or mostly transparent so that the LED filament can be seen through the envelope. Optionally, the envelope can be tinted or coated, at least in part, with a colored or reflective coating to achieve desired light distribution or appearance effects.

An LED filament can be driven using any standard LED driver. For example, many bulb-replacement products are designed to run from AC line voltage at 120 V or 240 V. The driver converts line voltage to a constant-current DC level at a voltage suitable to drive a particular series string (or a set of such strings in parallel). Drivers can be built into the base of a bulb-replacement product or can be located remotely from an LED filament. Drivers can be configured to drive single LED filaments or a plurality of LED filaments (for example, to drive all of the “bulbs” of a chandelier).

### Example

An Edison-style antique bulb product was made as shown in FIG. 1A. The envelope was made to mimic the original bulb. The base was a standard E26 Edison screw base. A driver was located in the base providing 80 mA constant current output at about 12 VDC from a 120 VAC input. A single LED filament was configured by mounting 40 LEDs (NSSLT02A-V2 made by Nichia Corp., Anan, Japan) on a double-sided KAPTON® flexible substrate (EI du Pont de Nemours and Co., Wilmington, Del.). The LEDs were wired in four parallel columns of 10 series LEDs. The substrate was about 10 cm long, 2.5 mm wide, and 25 μm thick. The assembled filament was coated with QSil 217 silicone (Quantum Silicones, LLC, Richmond, Va.) loaded with HB-6040 phosphor (Zhuhai Hanbo Trading Co., Ltd., Guangdong, China).

Antique bulb products of this type can be made with detachable envelopes or sealed as a unitary product. For example, interchangeable envelopes can be mounted on standard bases to extend the range of product configurations that can be offered by mixing and matching bases, filaments, and envelopes.

The foregoing describes exemplary embodiments of the present invention, and modifications obvious to those skilled in the engineering arts can be made thereto without departing from the scope of the present invention.

What is claimed is:

1. A light-emitting device comprising
a flexible substrate, and
a plurality of light emitting diodes (LEDs) mounted to the substrate;
wherein the flexible substrate has a length at least ten times a width,
wherein the plurality of LEDs are distributed substantially uniformly along the length of the flexible substrate,
wherein the length of the flexible substrate is disposed along a curved path, and
wherein the light-emitting device looks substantially like an incandescent filament when lit.

2. The light-emitting device of claim 1, further comprising a polymer coating disposed over and around the flexible substrate and the plurality of LEDs and configured to scatter or diffuse light from the plurality of LEDs such that the light-emitting device appears to emit light substantially uniformly along its length, and discrete LEDs cannot be discerned.

3. The light-emitting device of claim 2, wherein the polymer coating further comprises a phosphor operable to convert light emitted by the plurality of LEDs to longer wavelengths.

4. The light-emitting device of claim 2, wherein the polymer coating comprises silicone.

5. The light-emitting device of claim 1, wherein at least a portion curved path has a helical shape.

6. The light-emitting device of claim 1, further comprising a bulb-shaped envelope surrounding the flexible substrate.

7. The light-emitting device of claim 1, further comprising a driver operable to provide controlled electrical current to the plurality of LEDs.

8. The light-emitting device of claim 1, further comprising a screw-style lamp base.

9. The light-emitting device of claim 1, further comprising a bayonet-style lamp base.

10. A method of making a light-emitting device comprising
forming a printed circuit on an elongated flexible substrate, the substrate having a length at least ten times a width,
mounting and electrically connecting a plurality of LEDs on the elongated flexible substrate,
coating the elongated flexible substrate with a polymer coating, and
forming the elongated flexible substrate into a curved shape.

11. The method of claim 10, further comprising loading the polymer coating with a phosphor operable to convert light emitted by the plurality of LEDs to longer wavelengths.

12. The method of claim 10, further comprising connecting the two ends of the elongated flexible substrate to a lamp base.

13. The method of claim 12, further comprising mounting a driver circuit in the lamp base and connecting electrical pads at the two ends of the elongated flexible substrate to the output terminals of the driver circuit.

14. The method of claim 10, further comprising inserting the elongated flexible substrate into a transparent glass or plastic envelope.
